(19) United States
(12) Patent Application Publication
(10) Pub. No.: US 2011/0155116 A1
(43) Pub. Date: Jun. 30, 2011

(54) STEAM SYSTEM, IN PARTICULAR FOR RACK OVENS

(75) Inventor: Michael Koos, Arnstein (DE)

(73) Assignee: MIWE MICHAEL WENZ GMBH, Arnstein (DE)

(21) Appl. No.: 12/737,558

(22) PCT Filed: Jul. 24, 2009
(86) PCT No.: PCT/EP2009/059590

§ 371 Date: Jan. 25, 2011

(30) Foreign Application Priority Data
Jul. 29, 2008 (DE) 10 2008 035 394.9

(51) Int. Cl. A21B 1/08

(52) U.S. Cl. 126/20

(57) ABSTRACT

A baking oven includes an oven housing which has a baking chamber for receiving a baking carriage, a heating device, a fan which generates a flow of a heating medium from the heating device into the baking chamber and back, and a steam system which is arranged in the baking chamber and comprises at least one metal heat storage body and a water supply device. The system described herein provides a baking oven of the type in question in such a way that the thermal energy is optimally used. The steam system is next to a steam heater, which is formed by at least one exhaust gas channel, which runs in a wall of the baking chamber and conducts the exhaust gas of a burner out of the oven housing.

### TECHNICAL FIELD

The invention relates to a baking oven having

an oven housing which has a baking chamber for receiving a baking carriage,

a heating device,

a fan which generates a flow of a heating medium from the heating device into the baking chamber and back,

a steam device which is situated in the baking chamber and includes at least one metallic heat storage body and a water supply device.

### STATE OF THE ART

Such a baking oven is, for example, known from DE 10 2006 044 593 A1. In this baking oven, the fan is situated above the top wall of the baking chamber. It suctions off the heating medium through this top wall after flowing through the baking chamber and conveys it to a heating register. The air flows from the fan through a horizontal flow channel or a vertical flow channel to the heating register which is situated in the vertical flow channel. After that, the air flows through a steam device 20 having a large number of steam bars situated one above the other. The air, which has passed through gaps between steam bars lying one above the other, flows through outflow openings in a side wall of the baking chamber into the baking chamber. This design has proven to be effective and reliable. The positioning of the steam device directly adjacent to the heating register and the burner lying under the heating register provides for a good heat transfer of the heat of the burner onto the steam device.

On the other hand, a problem may result in prolonged operation of the steam device. The heating medium (normally heated air) flows through air adjustment plates, which are situated directly in front of the steam bars, and through the steam bars themselves which are situated one above the other at a distance from one another. The gaps between the air adjustment plates are relatively narrow. When the baking chamber is steamed, i.e., when a plume of water vapor is supplied, water is sprayed into the steam device which vaporizes when in contact with the steam bars. The vaporizing water produces calcium deposits and other residues on the steam bars and on the air adjustment plates. These residues may, in particular, reduce the size of the gaps between the air adjustment plates. This may cause the quantity of air flowing through in the area of smaller gaps to be reduced. If, for example, the width of the gaps is reduced due to deposits in the area of the upper steam bars, the quantity of air flowing through may be less there than in other areas and the heat transfer to baked goods is less effective there. This may cause the baking to be irregular. In practice, the steam devices must be regularly serviced and cleaned and replaced, if necessary, in order to reliably avoid such irregular baking results.

From the prior art, it is known, for example, to provide steam devices completely outside of the oven (for example, as a separate component on the top of the oven housing) in the case of thermal oil ovens, for example. In the prior art, however, a steam device provided in the oven housing was usually situated in the flow path of the heating medium in order to ensure reliable heating of the steam rods.

A baking oven is known from AT 383 471 B in which a steam device is accommodated in the lower area on both sides of the baking chamber. DE 200 03 484 U1 shows an externally heated steam generator which is situated outside of the baking chamber.

### DISCLOSURE OF THE INVENTION

The object of the invention is to develop a baking oven according to the definition of the species in such a way that the thermal energy is more optimally used by the steam device in the baking chamber.

According to the invention, this objective is achieved in that the steam device is adjacent to a steam heater, which is formed by at least one exhaust gas channel, which runs in a wall of the baking chamber and conducts the exhaust gas of a burner out of the oven housing.

If the steam device is situated outside of the flow path of the heating medium, other measures must be provided for heating the steam device. However, the steam device and in particular deposits on the steam device no longer have an influence on the flow of the heating medium and consequently on the heat transfer from the heating device of the baking oven to the baked goods in the baking chamber.

According to the invention, the steam device is adjacent to a steam heater, which is formed by at least one exhaust gas channel, which conducts the exhaust gas of a burner from the oven housing. Similar to the embodiment of the prior art, the baking oven is preferably heated by an oil burner or gas burner. The greatest share of the heat energy of the burner is transferred to the heating medium in the oven via the heating register. However, the exhaust gas of the burner still has a considerable temperature when entering the exhaust gas channel. Situating the exhaust gas channel adjacent to the steam device as a steam heater makes it possible for the thermal energy remaining in the exhaust gas to be transferred to the steam device, in particular steam bars of the steam device.

If the heating medium flows into the baking chamber through a side wall delimiting the baking chamber, the steam device may be situated on the back wall of the baking oven. Consequently, it is not necessary to change the position of the fan, the heating register and the burner. In contrast to the known prior art, the steam device is merely removed from the side wall, through which the heating medium flows in, and is moved to the back wall.

In practice, a U-shaped exhaust gas channel may be situated in the back wall of the baking chamber and extend over the largest part of the width of the back wall. The steam bars of the steam device may extend over the width of the U-shaped exhaust gas channel. The exhaust gas in the exhaust gas channel then heats them over their complete extension.

In a preferred embodiment, a large number of heat storage elements is situated additionally in the area of the side wall delimiting the baking chamber. The heat storage elements are preferably firebricks. Several firebricks preferably extend over the entire width of the side wall of the baking chamber. A gap through which the heating medium passes is provided between firebricks lying one above the other. The firebricks are consequently situated at the location where the steam device was provided in the embodiment of the prior art. The firebricks store heat energy which is transferred to them via the heating medium and this makes it possible to keep the temperature in the baking oven constant.

In an alternative embodiment, a large-area heat storage element or a plurality of large-area heat storage elements may be situated in the area of the side wall which limits the baking chamber and through which the heating medium flows in. The large-area heat storage element or the large-area heat storage elements have pass-through openings, making it possible for the heating medium to flow through.

### BRIEF DESCRIPTION OF THE DRAWINGS

An embodiment of the invention will be described below with reference to the appended drawings.

FIG. 1 shows a front view of a baking oven according to the invention.

FIG. 2 shows a cutaway view of the baking oven from FIG. 1 with a view of the back wall.

FIG. 3 shows a cutaway top view of the baking oven according to the invention.

FIG. 4 shows a cutaway side view of the baking oven from the preceding figures.

### EMBODIMENT(S) OF THE INVENTION

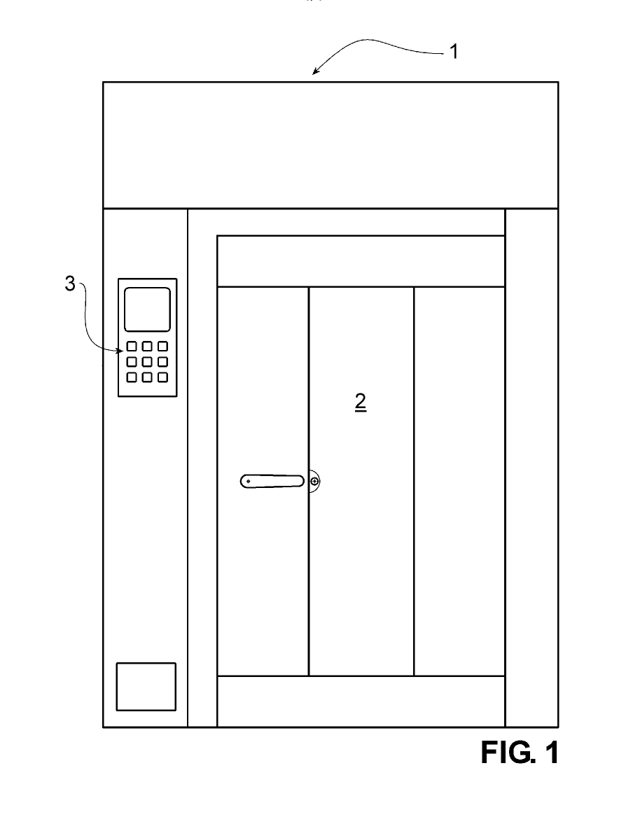

FIG. 1 shows a baking oven according to the invention which is normally used in bakeries or baked goods factories. The baking oven includes a housing 1 having a door 2 which is closed during the baking operation and may be used for putting in and removing the baked goods. Door 2 is approximately two meters tall and extends to the floor without a threshold. This ensures that it is possible for a baking carriage, also referred to as a rack carriage, to be pushed through the door opening into the baking chamber of the baking oven when door 2 is open. A control panel 3 having a display screen is also visible in FIG. 1. Control panel 3 may be used to enter parameters of the baking process (for example, duration, temperature, steaming) which are then displayed on the display screen of control panel 3 for the purpose of monitoring.

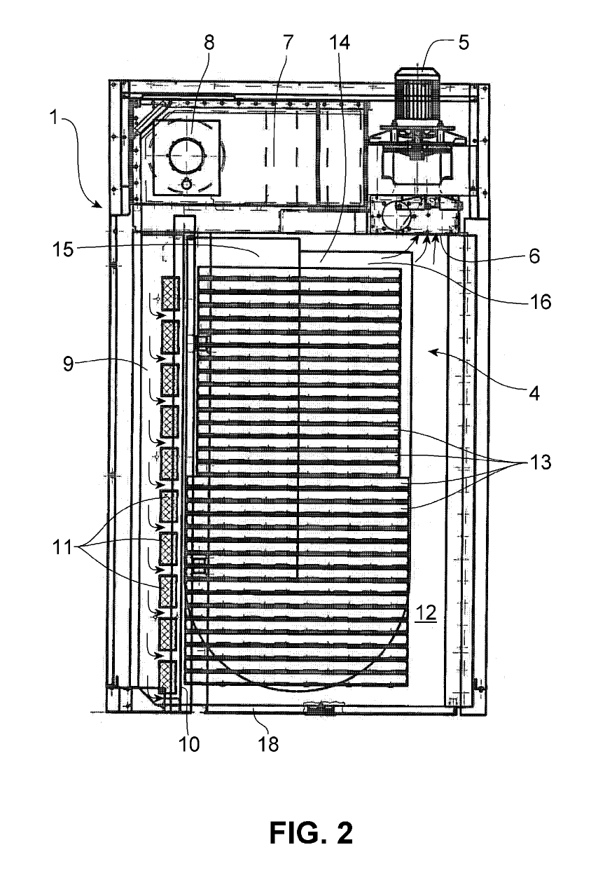

FIG. 2 shows a cutaway view of the baking oven according to the invention, the front side having the door cut away. The cross section of baking chamber 4 and the essential functional elements required for the baking operation are visible. A fan 5 is visible on the upper right in housing 1 of the baking oven. This fan 5 suctions a heating medium, which is normally made up of heated air, out of baking chamber 4 through its top wall 6. A flow control valve or a slide may be provided in the area of top wall 6 in order to vary the flow cross section for the suctioned heating medium and thus influence the quantity of heat supplied to the baked goods in baking chamber 4.

From fan 5, the heating medium flows through a heating register 7 which is heated by a burner 8. Burner 8 is normally operated using oil or gas. The air heated in this way then flows into a feed channel 9 which is located on the left in the section of oven housing 1 shown in FIG. 2. Feed channel 9 extends over the entire height of baking chamber 4 and is adjacent to its left side wall 10. Elongated firebricks 11 are situated in feed channel 9 directly adjacent to left side wall 10. The heated heating medium heats them to its temperature. If, for example, the heating medium is cooled by opening the oven door and putting in new baked goods, the heat storage capacity of firebricks 11 ensures that the heating medium rapidly returns to the intended temperature once the oven door has been closed again. Firebricks 11 consequently form heat storage elements for heating the heating medium.

Firebricks 11 are distributed at a distance from one another over the height of left side wall 10 of the baking chamber. The gaps between the firebricks define the flow path of the heating medium. Left side wall 10 of baking chamber 4 is made up of a metal plate having perforations which make it possible for the heating medium to enter baking chamber 4.

Heat storage bodies 13 are situated on back wall 12 of baking chamber 4 which is visible in FIG. 2. Heat storage bodies 13 are formed by elongated, U-shaped steam bars which are open at the top. A water supply device (not shown) makes it possible to supply water to steam bars 13. A plume of steam is thus generated in the known manner in baking chamber 4 and has a positive influence on the baking result.

Steam bars 13 are located on the back wall of baking chamber 4 and accordingly outside of the flow path of the heating medium which flows from left side wall 10 of baking chamber 4 to the upper right side of top wall 6 of the baking chamber. Consequently, deposits or other changes on steam bars 13 are unable to influence the flow of the heating medium through baking chamber 4.

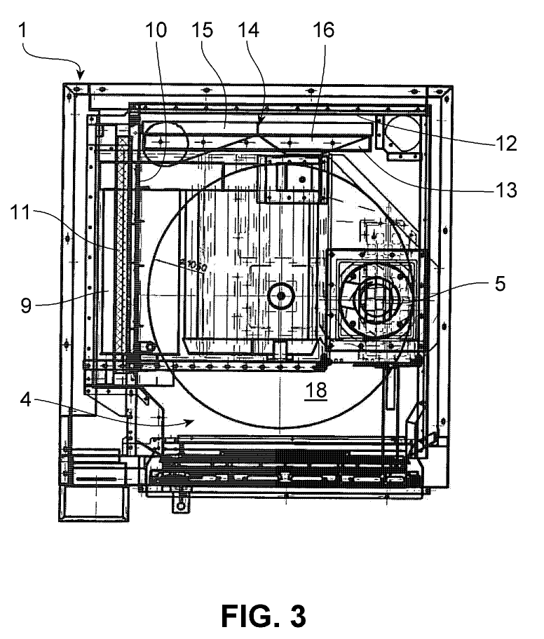

In order for steam bars 13 on back wall 12 of baking chamber 4 to maintain the required temperature, they are fastened to an exhaust gas channel 14 in the area of back wall 12 of baking chamber 4. As is visible in particular in FIG. 3, exhaust gas channel 14 has a flat rectangular cross section and is U-shaped. In other words, exhaust gas channel 14 is made up of two channel halves 15, 16 which lie adjacent to one another, are separated from one another and are connected to one another in the lower area of back wall 12 by a U-shaped channel deflection. The exhaust gas of burner 8 flows through an exhaust gas pipe into channel halves 15 which are on the left in FIGS. 2 and 3. In channel half 15, the exhaust gas flows downward to the U-shaped deflection and then upwards through right channel half 16. From there it flows to an outlet where it exits oven housing 1. The exhaust gas may either be driven through exhaust gas channel 14 by the overpressure caused by the combustion or it may also be suctioned off. An energy recovery unit having a fan which suctions off the exhaust gas from exhaust gas channel 14 by a slight underpressure may be provided in the second case.

Exhaust gas channel 14, to which steam bars 13 are fastened, has two advantages in particular. On the one hand, steam bars 13 are brought to the required operating temperature. On the other hand, the exhaust gas within oven housing 1 is cooled down again and exits at a reduced temperature. This increases the thermal efficiency of the baking oven.

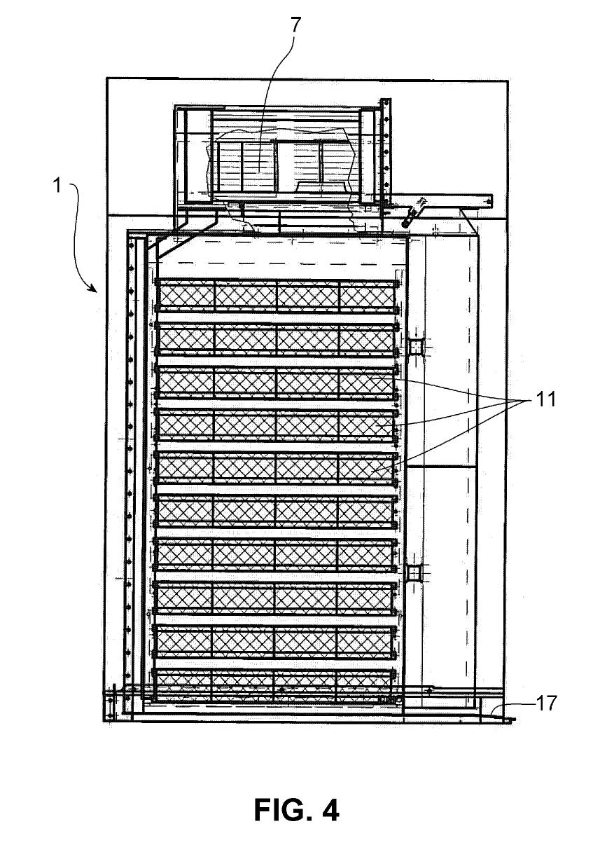

Ramp 17, which makes it possible for a baking carriage to be rolled into baking chamber 4, is visible in FIG. 4. Furthermore, FIGS. 2 and 3 show a turntable 18 onto which a baking carriage may be pushed so that it may be rotated during the baking operation. Turntable 18 has a diameter exceeding 1 meter. However, the baking carriage may also be rotated without turntable 18 using other means.

List of Reference Numerals

1 Housing

2 Door

3 Control panel

4 Baking chamber

5 Fan

6 Top wall

7 Heating register

8 Burner

9 Feed channel

10 Side wall

11 Firebrick, heat storage element

12 Back wall

13 Heat storage body, steam bar

14 Exhaust gas channel

15 Channel half

16 Channel half

17 Ramp

18 Turntable

1. A baking oven, comprising:
an oven housing which has a baking chamber for receiving a baking carriage;
a heating device;
a fan which generates a flow of a heating medium from the heating device into the baking chamber and back; and
a steam device which is situated in the baking chamber and includes at least one metallic heat storage body and a water supply device, wherein the steam device is adjacent to a steam heater which is formed by at least one exhaust gas channel which runs in a wall of the baking chamber and conducts the exhaust gas of a burner out of the oven housing.

2. The baking oven as recited in claim 1, wherein the heating medium flows into the baking chamber through a side wall delimiting the baking chamber, and the steam device is situated on the back wall of the baking oven.

3. The baking oven as recited in claim 1, wherein the steam device is situated outside of the flow path of the heating medium.

4. The baking oven as recited in claim 2, further comprising:
a U-shaped exhaust gas channel is situated in the back wall of the baking chamber.

5. The baking oven as recited in claim 2, further comprising:
heat storage elements situated in the area of the side wall delimiting the baking chamber.

6. The baking oven as recited in claim 5, wherein the heat storage elements are formed by firebricks.

7. The baking oven as recited in claim 6, further comprising:
pass-through openings, through which the heating medium flows, provided between the heat storage elements.

8. The baking oven as recited in claim 2, further comprising:
at least one heat storage element provided in the area of the side wall delimiting the baking chamber, the heat storage element having pass-through openings through which the heating medium flows.

9. The baking oven as recited in claim 8, wherein the steam device is situated outside of the flow path of the heating medium.

10. The baking oven as recited in claim 9, further comprising:
a U-shaped exhaust gas channel situated in the back wall of the baking chamber

11. The baking oven as recited in claim 8, wherein the at least one heat storage element includes a firebrick.
